(19) United States
(12) Patent Application Publication
(10) Pub. No.: US 2015/0165579 A1
(43) Pub. Date: Jun. 18, 2015

(54) Vehicle Frame Anchoring and Alignment Platform System

(71) Applicant: Thomas R. Thomas, Perry, UT (US)

(72) Inventor: Thomas R. Thomas, Perry, UT (US)

(21) Appl. No.: 14/566,871

(22) Filed: Dec. 11, 2014

Related U.S. Application Data
(60) Provisional application No. 61/914,929, filed on Dec. 11, 2013.

(51) Int. Cl. B23Q 3/18

(52) U.S. Cl. CPC B23Q 3/186

(57) ABSTRACT

The present invention is a vehicle frame anchoring and alignment platform system. Because of the adjustability and modularity of the vehicle frame anchoring and alignment platform system, the system is adapted to minimize pull setups and takedowns, tool assembly and disassembly, and vehicle disassembly and assembly when used in aligning a vehicle frame.

### CROSS REFERENCE TO RELATED APPLICATIONS

This US nonprovisional utility patent application claims the benefit under 35 USC §119(e) of U.S. provisional application No. 61/914,929 filed Dec. 11, 2013 which is incorporated in its entirety by this reference.

### FIELD OF THE INVENTION

The present invention relates to apparatuses and devices for use in anchoring and aligning vehicle frames.

### BACKGROUND OF THE INVENTION

Vehicle frame anchoring and alignment platforms (platform) are well known in the art and have wide spread usage in repairing vehicles that have been involved in a collision. An exemplary platform is the CAR-O-LINER platform available from the Car-O-Liner Corporation (see Appendix A) which is incorporated herein in its entirety by reference. The CAR-O-LINER platform is a so-called “tool board assembly system” (TBAS), so termed due to the need to assembly several different tooling components for each vehicle alignment pull setup. Furthermore, such TBAS platform lack significant anchoring strength or adjustability (in the horizontal plane, the vertical plane or rotationally).

For instance, in order to perform an alignment pull on a larger vehicle such as a FORD super duty pickup truck (e.g. an F150, an F250, an F350, etc.), due to the limited ability and range of motion of the CAR-O-LINER TBAS, the wheels of the larger vehicle must be removed from the larger vehicle to perform the pull setup and the pull. Further for instance, in order to perform an alignment pull on both the front end and the rear end of a vehicle when using the CAR-O-LINER TBAS, due to the limited holding strength and limited adaptability of the CAR-O-LINER TBAS, a user must perform a first (front or rear) pull setup, a first pull, a first pull takedown, a second pull setup (front or rear), a second pull, and a second pull takedown. Such multiple setups and takedowns are inefficient and result in lower operating profits for the user of the platform.

Modular frame attachment apparatuses having superior holding strength are known in the art. An exemplary frame attachment apparatus is disclosed in U.S. Pat. No. 7,150,176 to Thomas and is incorporated in its entirety by this reference.

### SUMMARY OF THE INVENTION

The present invention is a vehicle frame anchoring and alignment platform having adjustable modular frame attachment apparatuses of superior holding strength and of significant rotational and positional range of motion.

### DESCRIPTION OF DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a first trimetric view of a first embodiment of the platform with the attachment apparatus base assembly attached to the platform arm and with the attachment apparatus post assembly removed from the attachment apparatus base assembly;

FIG. 2 is a second trimetric view of a first embodiment of the platform with the attachment apparatus base assembly attached to the platform arm and with the attachment apparatus post assembly removed from the attachment apparatus base assembly;

FIG. 3 is an enlarged third trimetric view of a first embodiment of the platform with the attachment apparatus base assembly attached to the platform arm and with the attachment apparatus post assembly not shown;

FIG. 4 is a fourth trimetric view of a first embodiment of the platform with the attachment apparatus assembly attached to the platform arm;

FIG. 5 is a trimetric view of a set of four attachment apparatuses, and;

FIG. 6 is an enlarged trimetric view of an attachment apparatus.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are included to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

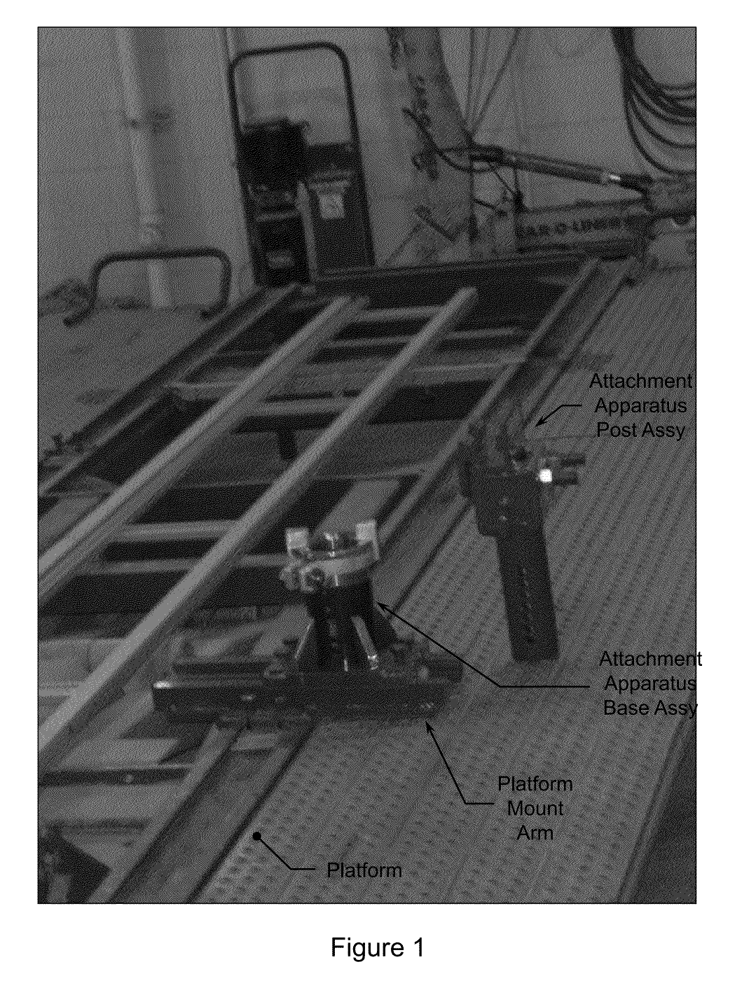

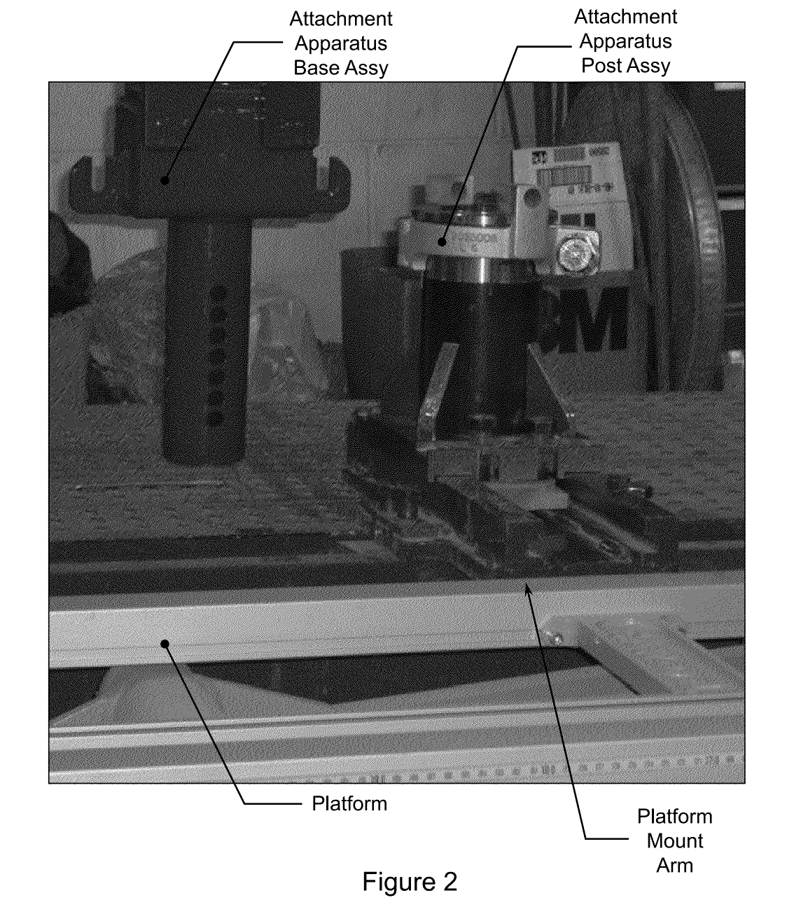

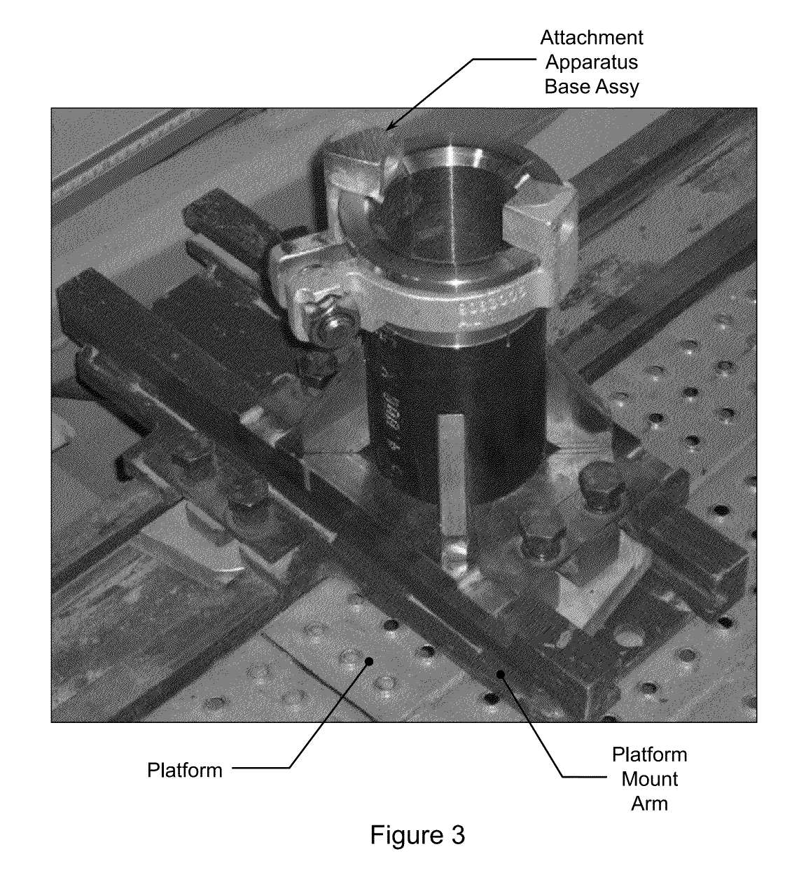

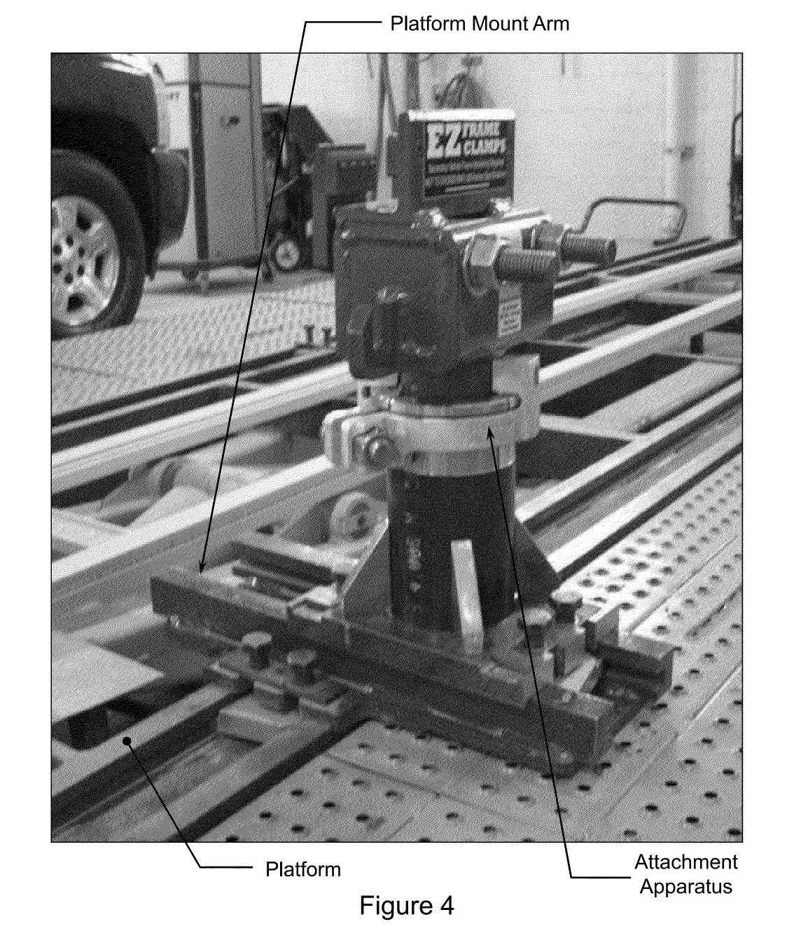

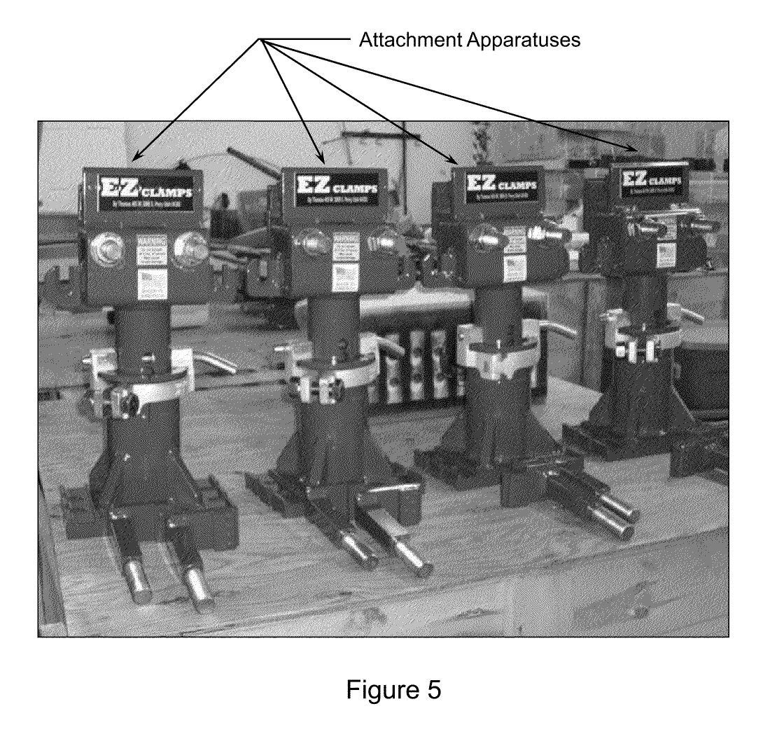

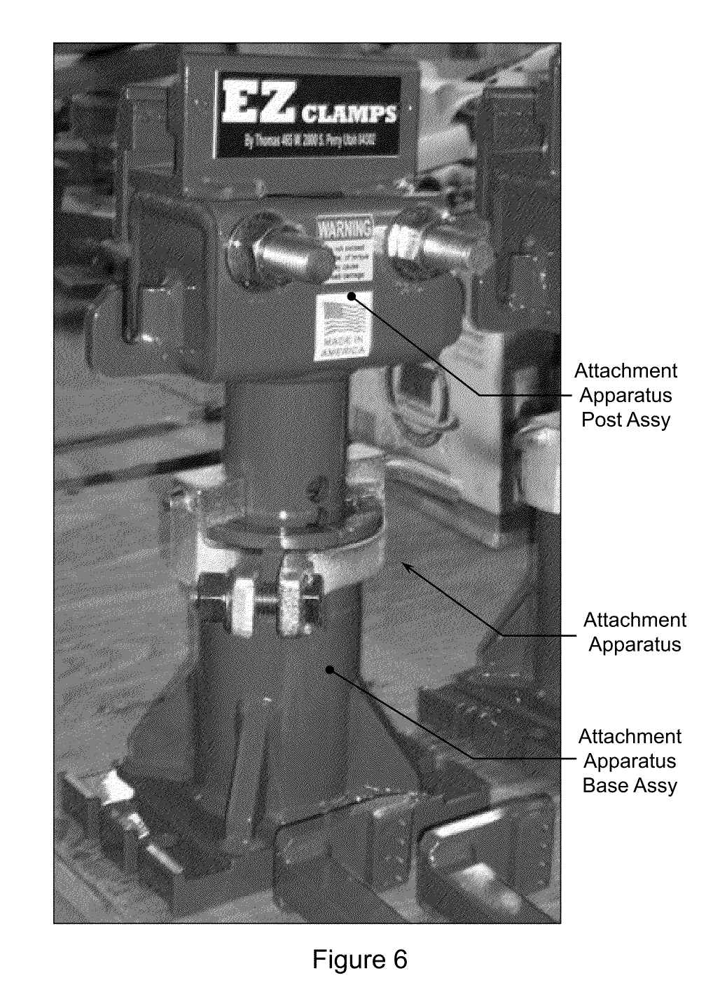

Referring now to FIGS. 1 through 6 of the drawings, a first embodiment of the invention is a vehicle frame anchoring and alignment platform system. The system comprises a platform, a plurality of mount arms, and a plurality of modular attachment apparatuses. Each attachment apparatus further comprises a base assembly and a post assembly.

The system is assembled such that preferably at least four mount arms are repositionably secured to the platform, an attachment apparatus base assembly is repositionably secured to each mount arm, and an attachment apparatus post assembly is rotatably and extendably and retractably secured to each base assembly. It is noted that the post assembly, with respect to the base assembly, is preferably rotatably repositionable in a full 360 degree range of repositioning, and that the post assembly, with respect to the base assembly, is preferably extendably and retractably repositionable to 18 inches of linear repositioning but may be more or less than 18 inches of linear repositioning such as 24 inches of linear repositioning, 30 inches of linear repositioning, or 36 inches of linear repositioning. It is further noted that the combination of repositioning of the mounting arms and the base assemblies provides for significant X-Y plane or horizontal repositionability.

In practice, a vehicle frame (typically complete with a damaged vehicle fastened thereto) is positioned in the grips of the post assembly and secured such that the frame does not release under load. At select locations on the frame, the frame is subsequently secured to a pull tower and an alignment pull load is placed on the vehicle frame such that the vehicle is aligned to a predetermined or desired alignment. It is noted that the alignment platform system is adapted such that setups and takedowns for a given vehicle repair are minimized and such that obtaining and assembling tools from a tool board is minimized or completely eliminated. It is further noted that the alignment platform system is adapted such that the repair of large and discrete frame (as opposed to mere unibody) vehicle can be performed, including front and rear alignment pulls, in a single setup and without removing the wheels of such vehicle.

What is claimed is:

1. A vehicle frame anchoring and alignment platform system comprising a vehicle frame anchoring and alignment platform having at least one repositionable mount arm, and each of said at least one mount arm having an attachment apparatus according to the disclosure of U.S. Pat. No. 7,150,176 repositionably secured to said at least one mount arm.

2. The system of claim 1, wherein said platform defines a CAR-O-LINER platform.

3. The system of claim 1, wherein said platform defines an adapted tool board platform.

4. The system of claim 1, wherein when said system is used in aligning a frame, the setups required to align said frame are minimized.

5. The system of claim 4, wherein said minimized setups define a single setup.

6. The system of claim 1, wherein when said system is used in aligning a frame that is attached to a large vehicle, said alignment is performed without disassembling said vehicle.

7. The system of claim 1, wherein said attachment apparatus is rotationally repositionable in a 360 degree range of repositionability.

8. The system of claim 1, wherein said attachment apparatus is vertically repositionable in an at least 18 inch range of vertical repositionability.
